(19) United States
(12) Patent Application Publication
(10) Pub. No.: US 2012/0020099 A1
(43) Pub. Date: Jan. 26, 2012

(54) SIDE-VIEW MIRROR ASSEMBLY WITH SELECTIVELY ILLUMINATING PORTION

(76) Inventor: Rob Bingle, Walker, MI (US)

(21) Appl. No.: 13/166,526

(22) Filed: Jun. 22, 2011

Related U.S. Application Data
(60) Provisional application No. 61/357,247, filed on Jun. 22, 2010.

(51) Int. Cl. B60Q 1/00

(52) U.S. Cl. 362/464

(57) ABSTRACT

A side-view mirror assembly for a vehicle, comprising a housing for securement to a side of a vehicle, the housing defining an internal cavity opening toward a rear of the housing, the internal cavity having a mirror disposed therein, and the housing having an exterior surface at least partially formed from a light-transmissive material all but a portion of which has been covered with an opaque material. At least one light source is disposed within the housing and is operable to illuminate the uncovered, light-transmissive portion of the housing. The at least one light source is operatively connectable to a controller programmed so as to selectively illuminate the at least one light source in response to the occurrence of one or more predefined activities.

### CROSS-REFERENCE TO RELATED APPLICATIONS

This application is related to, and claims the benefit of priority from, prior-filed U.S. Provisional Application Ser. No. 61/357,247, filed 22 Jun. 2010, the disclosure of which is incorporated herein by reference in its entirety.

### FIELD OF THE INVENTION

The present disclosure relates generally to side-view mirrors for vehicles, including motor vehicles such as automobiles, and more particularly to such side-view mirrors having a selectively illuminating portion.

### BACKGROUND

Side-view mirrors for vehicles have heretofore been modified with lighting features such as turn-signal indicators that illuminate when the driver actuates the vehicle's turn signals. Typically, these lighting features, which enhance safety for the driver as well as other motorists in the vicinity, are visible from the rear (i.e., behind the position of the driver) of the vehicle. However, these and other prior art lighting features are relatively complex in their construction; and so there continues to exist a need for side-view mirror lighting features that are relatively economical to build while also having utility and pleasing aesthetics.

### SUMMARY

There is disclosed herein a side-view mirror assembly for a vehicle, comprising a housing for securement to a side of a vehicle, the housing defining an internal cavity opening toward a rear of the housing, the internal cavity having a mirror disposed therein, and the housing having an exterior surface at least partially formed from a light-transmissive material all but a portion of which has been covered with an opaque material. At least one light source is disposed within the housing and is operable to illuminate the uncovered, light-transmissive portion of the housing. The at least one light source is operatively connectable to a controller programmed so as to selectively illuminate the at least one light source in response to the occurrence of one or more predefined activities.

Per one feature, the one or more predefined activities are selected from the group consisting of detecting an object within a predetermined distance from the vehicle, locking of the vehicle, unlocking of the vehicle, activation of a turn signal of the vehicle, detection of a remote control unit within a predetermined distance from the vehicle, and activation of a remote control unit for the vehicle.

Per one feature, the housing comprises each of a base part defining the internal cavity having the mirror disposed therein, and a cap securable over the base part to define a portion of the exterior surface of the side-view mirror assembly. The cap and base part define a seam along the exterior surface of the side-view mirror assembly where adjacent edges of the cap and base part are opposed. At least one of the cap and base part comprise the light-transmissive material all but a portion of which has been covered with an opaque material. The uncovered, light-transmissive portion of the housing is defined on at least one of the cap or base part proximate the seam defined where adjacent edges thereof are opposed.

Per another feature, the at least one light source may comprise at least one LED and a light pipe. The light pipe may, furthermore, be substantially coextensive with the uncovered, light-transmissive portion of the housing.

In one embodiment, the uncovered, light-transmissive portion of the housing is defined by masking the housing before the housing is covered with the opaque material.

In an alternative embodiment, the uncovered, light-transmissive portion of the housing is defined by removing the opaque material from that portion of the housing.

According to a still further feature, the one or more light sources comprise a plurality of light sources, each light source emitting light of a different color from the other light sources. According to this feature, for each of the one or more predefined activities, the controller is programmed to effect selective illumination of the light sources to illuminate the uncovered, light-transmissive portion in one of the different colors.

Per another feature, the one or more light sources comprise at least one light source capable of selectively emitting light of different colors, each light source emitting light of a different color from the other light sources. According to this feature, for each of the one or more predefined activities, the controller is programmed to effect selective illumination of the at least one light source to illuminate the uncovered, light-transmissive portion in one of the different colors.

Per yet another feature, the inventive side-view mirror further comprises a controller disposed in the housing, the controller operatively connectable to a controller for the vehicle and programmed so as to selectively illuminate the at least one light source in response to indication by the controller for the vehicle that one or more of the predefined activities has occurred. The controller may, for example and without limitation, comprise a printed circuit board electronically connectable to the controller for the vehicle.

### DESCRIPTION OF THE DRAWINGS

For a better understanding of the present invention and to show more clearly how it may be carried into effect, reference will now be made, by way of example, to the accompanying drawings, in which:

FIG. 1 illustrates a side-view mirror assembly for a vehicle having an illuminating portion according to an exemplary embodiment of the present invention; and

FIG. 2 illustrates the side-view mirror assembly of FIG. 1 with the illuminating portion illuminated.

### DESCRIPTION

As required, a detailed description of an exemplary embodiment of the present invention is disclosed herein. However, it is to be understood that the disclosed embodiment is merely exemplary of the invention, which may be embodied in various and alternative forms. The accompanying drawings are not necessarily to scale, and some features may be exaggerated or minimized to show details of particular components. Therefore, specific structural and functional details disclosed herein are not to be interpreted as limiting, but merely as providing a representative basis for teaching one skilled in the art to variously employ the present invention.

Referring now to the drawings, wherein like numerals refer to like or corresponding parts throughout the several views, the present invention may seen to generally comprise a side-view mirror assembly for a vehicle, the side-view mirror assembly including a housing for securement to a side of a vehicle, the housing defining an internal cavity opening toward a rear of the housing, the internal cavity having a mirror disposed therein, and the housing having an exterior surface at least partially formed from a light-transmissive material all but a portion of which has been covered with an opaque material. Further, at least one light source is disposed within the housing and is operable to illuminate the uncovered, light-transmissive portion of the housing. The at least one light source is operatively connectable to a controller programmed so as to selectively illuminate the at least one light source in response to the occurrence of one or more predefined activities.

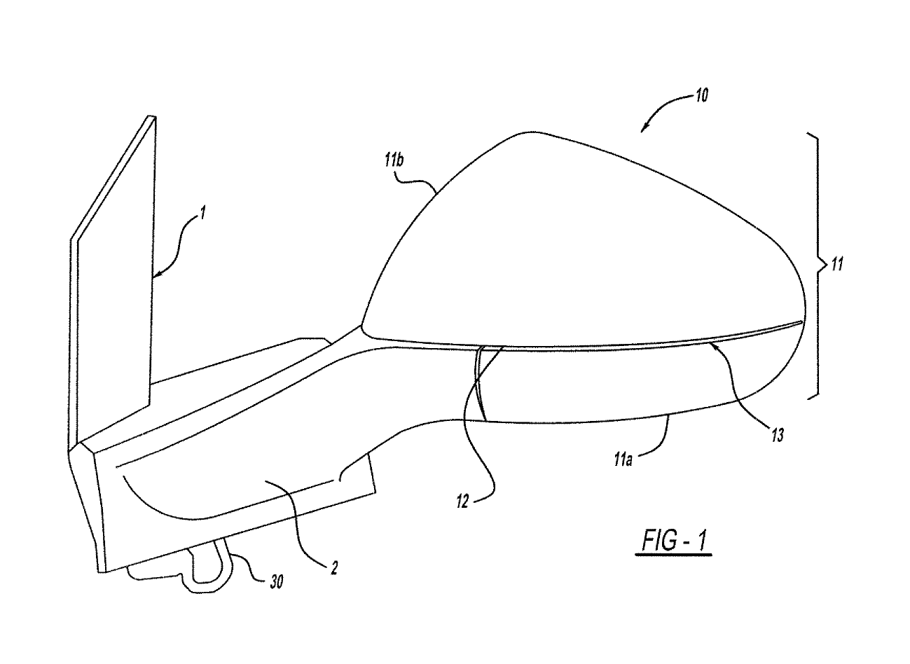

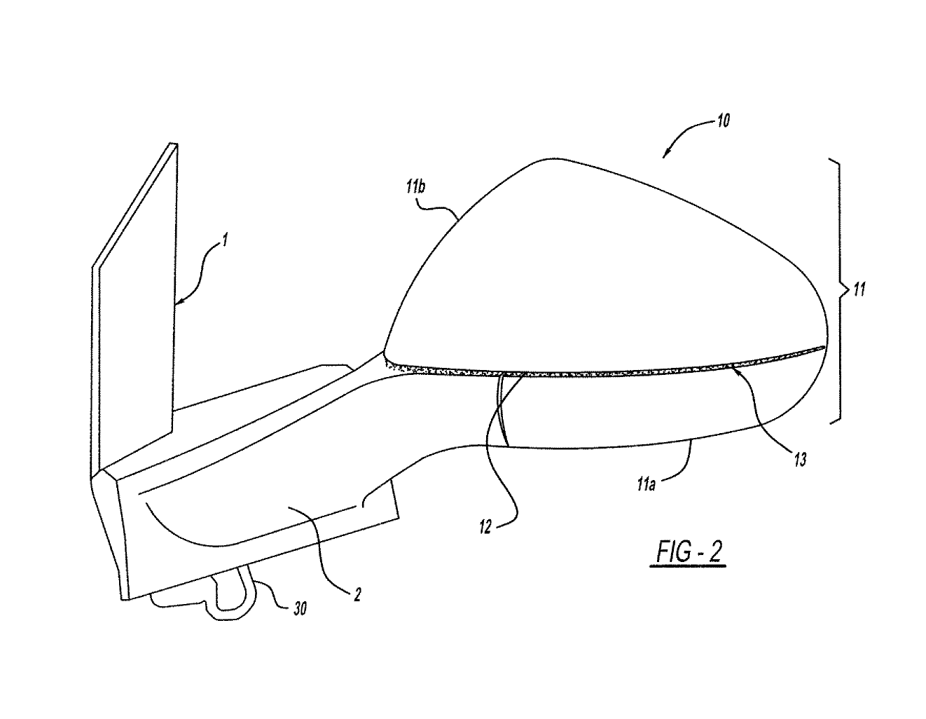

Referring to the FIGS. 1 and 2 more particularly, there is illustrated a side-view mirror assembly 10 for mounting to a vehicle, according to an exemplary embodiment of the present invention. In this example, the side-view mirror assembly 10 comprises a housing (indicated generally at 11) securable to a side of a vehicle (partially shown at 1, depicting a portion of a vehicle door) via a mirror mount 2. Per convention, the housing 10 defines an internal cavity (not depicted) opening toward a rear of the housing and having a mirror (not depicted) disposed therein. Mirror may, per convention, be supported on a mount for motorized or non-motorized movement relative thereto. For instance, the mirror can be electrically coupled to a control mechanism accessible to a user of the vehicle. Electrical components, such as wires and circuit boards, etc., can be hidden from view within the cavity formed by the housing 10. Typically, these components sit in the cavity behind the mirror.

As shown in FIGS. 1 and 2, the housing 10 has an exterior surface, which exterior surface is at least partially formed from a light-transmissive material, such as, by way of non-limiting example, translucent or transparent plastic, all but a portion 12 of which has been covered with an opaque material, such as, by way of example only, paint. Where the opaque material is paint, it will be appreciated that the uncovered, light-transmissive portion 12 of the housing may be fashioned by masking prior to painting, or by paint removal in a post-paint process.

According to the illustrated embodiment of FIGS. 1 and 2, the housing 11 is a multi-part unit comprising a base part 11a defining the internal cavity having the mirror disposed therein, and a cap 11b securable over the base part 11a (such as via one or more of adhesives, locking tabs, fasteners, etc.) to define a portion of the exterior surface of the side-view mirror assembly 10. The cap 11b and base part 11a define a seam 13 along the exterior surface of the side-view mirror assembly where adjacent edges of the cap 11b and base part 11a are opposed, According to the present invention, at least one of the cap 11b and base part 11a comprise the light-transmissive material all but a portion 12 of which has been covered with an opaque material, as described above, so that the uncovered, light-transmissive portion of the housing is defined on at least one of the cap or base part proximate, and substantially coextensive with, the seam 13 defined between adjacent edges thereof. Accordingly to this exemplary construction, the uncovered, light-transmissive portion 12 of the housing is relatively unnoticeable unless illuminated by the light source.

At least one light source (not shown) such as, for example, one or more LEDs, is disposed within the housing 10 and is operable to illuminate the uncovered, light-transmissive portion 12 of the housing. The light source is connectable (such as via cables 30 extending through mount 2) to a controller of a vehicle so as to emit light when instructed by the vehicle controller. Optionally, the at least one light source is connected to a controller, such as a printed circuit board (PCB) disposed in the housing 10, such controller in turn being operatively connectable to a controller for the vehicle and programmed so as to selectively illuminate the at least one light source when instructed by the vehicle controller.

As will be appreciated, illumination of the uncovered, light-transmissive portion 12 of the housing can occur in response to the occurrence of one or more vehicular activities, such as, by way of example and not limitation, detecting an object within a predetermined distance from the vehicle, braking of the vehicle, acceleration of the vehicle, locking of the vehicle, unlocking of the vehicle, activation of a turn signal of the vehicle, detection of a remote control unit within a predetermined distance from the vehicle, opening of the trunk of the vehicle, starting the vehicle, and activation of a remote control unit for the vehicle, etc. Optionally, the illumination may be in one or more colors, selectively or simultaneously. For instance, the at least one light source can provide a plurality of illumination colors, each of which corresponds to a designated vehicular activity (such as, for instance, activities chosen from those identified above). Thus, for example: braking can cause a red illumination of the uncovered, light-transmissive portion 12; locking can cause a blue illumination; etc. Such multi-color illumination may be accomplished by one (such as, for instance, RGB LEDs) or more light sources, depending upon the particular application.

In one embodiment, the at least one light source may comprise at least one LED and a light pipe (not shown), the light pipe substantially coextensive with the uncovered, light-transmissive portion 12 of the housing so as to create an aesthetically pleasing lighting effect along the length of the uncovered, light-transmissive portion. Alternatively, or in addition, the at least one light source may comprise other conventional light sources such as, without limitation, electroluminescent (EL) light sources, organic light-emitting diodes (OLEDs), incandescent light sources, etc. Likewise, light guides, fiber optic lighting fibers, and other such conventional means may be used instead of, or in addition to, a light pipe in the exemplary embodiment.

The at least one light source is preferably, though not necessarily, visibly unnoticeable external of the side-view mirror assembly 10. Accordingly, the uncovered, light-transmissive portion 12 of the illustrated embodiment produces, when illuminated, a relatively thin, sleek and aesthetically pleasing light profile.

It will be appreciated from the above disclosure that the present invention provides freedom to add aesthetic lighting features without the visible lenses and light sources being revealed, thus improving on prior art side-view mirror assemblies.

The foregoing description of the exemplary embodiment of the invention has been presented in order to explain the principles of the innovation and its practical application so as to enable one skilled in the art to utilize the innovation. It is not intended to be exhaustive of, or to limit the invention to, the precise forms disclosed, and although only an exemplary embodiment of the present invention has been described in detail in this disclosure, those skilled in the art who review this disclosure will readily appreciate that many modifications are possible to the present invention without materially departing from the novel teachings and advantages of the subject matter herein recited. Other substitutions, modifications, changes and omissions may be made in the exemplary embodiment without departing from the spirit of the present invention and, accordingly, all such modifications, changes, etc. are intended to be included within the scope of the invention as hereinafter claimed.

1. A side-view mirror assembly for a vehicle, comprising:
a housing for securement to a side of a vehicle, the housing defining an internal cavity opening toward a rear of the housing, the internal cavity having a mirror disposed therein, and the housing having an exterior surface at least partially formed from a light-transmissive material all but a portion of which has been covered with an opaque material; and
at least one light source disposed within the housing and operable to illuminate the uncovered, light-transmissive portion of the housing, the at least one light source operatively connectable to a controller programmed so as to selectively illuminate the at. least one light source in response to the occurrence of one or more predefined activities.

2. The side-view mirror assembly of claim 1, wherein:
the housing comprises a base part defining the internal cavity having the mirror disposed therein, and a cap securable over the base part to define a portion of the exterior surface of the side-view mirror assembly;
the cap and base part define a seam along the exterior surface of the side-view mirror assembly where adjacent edges of the cap and base part are opposed;
at least one of the cap and base part comprise the light-transmissive material all but a portion of which has been covered with an opaque material; and
the uncovered, light-transmissive portion of the housing is defined on at least one of the cap or base part proximate the seam defined where adjacent edges thereof are opposed.

3. The side-view mirror assembly of claim 1, wherein the at least one light source comprises at least one LED and a light pipe.

4. The side-view mirror assembly of claim 3, wherein the light pipe is substantially coextensive with the uncovered, light-transmissive portion of the housing.

5. The side-view mirror assembly of claim 1, wherein the uncovered, light-transmissive portion of the housing is defined by masking the housing before the housing is covered with the opaque material.

6. The side-view mirror assembly of claim 1, wherein the uncovered, light-transmissive portion of the housing is defined by removing the opaque material from that portion of the housing.

7. The side-view mirror assembly of claim 1, wherein the one or more predefined activities are selected from the group consisting of detecting an object within a predetermined distance from the vehicle, braking of the vehicle, acceleration of the vehicle, locking of the vehicle, unlocking of the vehicle, activation of a turn signal of the vehicle, detection of a remote control unit within a predetermined distance from the vehicle, opening of the trunk of the vehicle, starting the vehicle, and activation of a remote control unit for the vehicle.

8. The side-view mirror assembly of claim 1, wherein the one or more light sources comprise a plurality of light sources, each light source emitting light of a different color from the other light sources.

9. The side-view mirror assembly of claim 8, wherein, for each of the one or more predefined activities, the controller is programmed to effect selective illumination of the light sources to illuminate the uncovered, light-transmissive portion in one of the different colors.

10. The side-view mirror assembly of claim 9, wherein the one or more predefined activities are selected from the group consisting of detecting an object within a predetermined distance from the vehicle, braking of the vehicle, acceleration of the vehicle, locking of the vehicle, unlocking of the vehicle, activation of a turn signal of the vehicle, detection of a remote control unit within a predetermined distance from the vehicle, opening of the trunk of the vehicle, starting the vehicle, and activation of a remote control unit for the vehicle.

11. The side-view mirror assembly of claim 1, comprising a controller disposed in the housing, the controller being operatively connectable to a controller for the vehicle and programmed so as to selectively illuminate the at least one light source in response to indication by the controller for the vehicle that one or more of the predefined activities has occurred.

12. The side-view mirror assembly of claim 11, wherein the controller is a printed circuit board electronically connectable to the controller for the vehicle.

13. The side-view mirror assembly of claim 9, wherein:
the housing comprises a base part defining the internal cavity having the mirror disposed therein, and a cap securable over the base part to define a portion of the exterior surface of the side-view mirror assembly;
the cap and base part define a seam along the exterior surface of the side-view mirror assembly where adjacent edges of the cap and base part are opposed;
at least one of the cap and base part comprise the light-transmissive material all but a portion of which has been covered with an opaque material; and
the uncovered, light-transmissive portion of the housing is defined on at least one of the cap or base part proximate the seam defined where adjacent edges thereof are opposed.

14. The side-view mirror assembly of claim 13, wherein the at least one light source comprises at least one LED and a light pipe.

15. The side-view mirror assembly of claim 14, wherein the light pipe is substantially coextensive with the uncovered, light-transmissive portion of the housing.

16. The side-view mirror assembly of claim 9, comprising a controller disposed in the housing, the controller being operatively connectable to a controller for the vehicle and programmed so as to selectively illuminate the at least one light source in response to indication by the controller for the vehicle that one or more of the predefined activities has occurred.

17. The side-view mirror assembly of claim 16, wherein the controller is a printed circuit board electronically connectable to the controller for the vehicle.

18. The side-view mirror assembly of claim 9, wherein the uncovered, light-transmissive portion of the housing is defined by masking the housing before the housing is covered with the opaque material.

19. The side-view mirror assembly of claim 9, wherein the uncovered, light-transmissive portion of the housing is defined by removing the opaque material from that portion of the housing.

20. The side-view mirror assembly of claim 9, wherein the at least one light source comprises at least one LED and a light pipe.

21. The side-view mirror assembly of claim 13, wherein the one or more predefined activities are selected from the group consisting of detecting an object within a predetermined distance from the vehicle, braking of the vehicle, acceleration of the vehicle, locking of the vehicle, unlocking of the vehicle, activation of a turn signal of the vehicle, detection of a remote control unit within a predetermined distance from the vehicle, opening of the trunk of the vehicle, starting the vehicle, and activation of a remote control unit for the vehicle.

22. The side-view mirror assembly of claim 1, wherein the one or more light sources comprise at least one light source capable of selectively emitting light of different colors, each light source emitting light of a different color from the other light sources.

23. The side-view mirror assembly of claim 22, wherein, for each of the one or more predefined activities, the controller is programmed to effect selective illumination of the at least one light source to illuminate the uncovered, light-transmissive portion in one of the different colors.

24. The side-view mirror assembly of claim 23, wherein the one or more predefined activities are selected from the group consisting of detecting an object within a predetermined distance from the vehicle, braking of the vehicle, acceleration of the vehicle, locking of the vehicle, unlocking of the vehicle, activation of a turn signal of the vehicle, detection of a remote control unit within a predetermined distance from the vehicle, opening of the trunk of the vehicle, starting the vehicle, and activation of a remote control unit for the vehicle.
